(19) United States
(12) Patent Application Publication
(10) Pub. No.: US 2021/0106190 A1
(43) Pub. Date: Apr. 15, 2021

(54) PeeWee Shots

(71) Applicant: Stephanie Ann Green, Milwaukie, OR (US)

(72) Inventor: Stephanie Ann Green, Milwaukie, OR (US)

(21) Appl. No.: 16/598,592

(22) Filed: Oct. 10, 2019

(51) Int. Cl. A47K 11/04; G09B 19/00

(52) U.S. Cl. CPC A47K 11/04; G09B 19/0076

(57) ABSTRACT

The purpose of this patent application is to obtain a patent on the PeeWee Shots potty training tool. The main purpose for this invention is to benefit caretakers in terms of helping to eliminate urine on surfaces. Also this will help train kids to aim properly into the toilet. Kids will also learn quicker and become very excited about wanting to use the toilet instead of diapers.

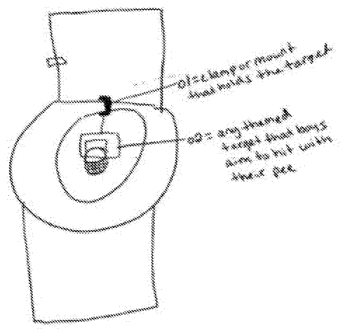

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This invention is a new invention in which no patents or ideas already exist. This is a brand new product that will be brought to the market. This invention does not improve any other product on the market. It is a new product and that is standalone. The main impetus for the PeeWee Shots toilet training apparatus is to train boys to properly pee into the toilet while encouraging aim, while reducing excess urine to splash on the back of the toilet, floor and onto the seat, Kids aim into the toilet and try and hit a target which can be a basketball hoop, golf hole in one, soccer goal, frogger game or anything similar.

The Peewee Shot is clipped/clammed onto the toilet, and boys shoot for the target and try at hit the center of the design, whether it be a basketball hoop, golf hole in one, soccer goal, football theme, game theme or anything that is fun for boys. The idea of the toilet training tool being clamped/clipped onto the toilet, and a boy aims with his pee to try and hit the target is the main reason for this patent. There is nothing on the market that clamps or clips onto a toilet and that boys aim and shoot for a target.

Stephanie Ann Green is a full-time working mother of 3 small kids with an MBA. Her house is comprised of 3 males and she is constantly trying to teach them to pee into the actual toilet instead of an the floor or on the back seat of the toilet. On an average day, she wipes off urine from her toilet 5 times a day and not to mention the bad urine smell that emulates in the bathroom. One day she was teaching her youngest child to try and pee into the existing base hole of the toilet and said “pretend it's a basketball hoop or soccer goal and aim for a goal”. That minute the PeeWee Shots was invented as a training tool for kids; to teach better aim and to alleviate urine on surfaces.

### BRIEF SUMMARY OF THE INVENTION

As mentioned above, there is a huge market and need for this product. The invention is comprised of an animal, sports theme, music, game theme, shape or character (all items or designs are in scope) that is clipped/mounted onto the toilet where the kids aim and pee to try and hit a target. Essentially this is a pee target for boys that is clipped onto the toilet and the target is mounted so it never touches the water.

### BRIEF DESCRIPTION OF THE SEVERAL VIEWS OF THE DRAWING

Please refer to separate diagram of the PeeWee Shots. Each element is properly labeled.

### DETAILED DESCRIPTION OF THE INVENTION

There is no other invention like this one the market. This is not an improved product patent either. The process is simple with existing materials on the market. All materials are on the market currently so it's a matter of assembling existing materials that are commercially available. This invention requires the use of a cool or attractive target (like an animal character, sports theme, musical theme or any other design) that boys aim and try and hit with their pee. The pee hits the target and the pee naturally falls or trickles into the toilet. The training toy clips or clamps onto the toilet seat. The target remains above toilet water level so it never touches the water.

1. A potty-training tool that is mounted or dipped to a toilet and has an attractive target, such as an animal face, musical instrument, sports theme etc., that is used as a target for boys to aim and hit with their pee.
(a) A potty-training tool with a themed target that mounts onto the toilet to help boys potty train.
(b) Ara animal, character, music instrument, sports theme or anything similar that is mounted onto a toilet to act as a target for boys to aim and hit with their urine.
(c) The urine hits the target and goes down the toilet.
